(19) United States
(12) Patent Application Publication
(10) Pub. No.: US 2005/0263558 A1
(43) Pub. Date: Dec. 1, 2005

(54) Nail gun

(75) Inventors: Yoshinori Ishizawa, Ibaraki (JP); Hiroki Kitagawa, Ibaraki (JP); Masashi Nishida, Ibaraki (JP); Masato Sakai, Ibaraki (JP); Takeshi Taniguchi, Ibaraki (JP)

Correspondence Address: McGinn & Gibb, PLLC, Suite 200, 8321 Old Courthouse Road, Vienna, VA, 22182-3817, US

(73) Assignee: Hitachi Koki Co., Ltd., Tokyo (JP)

(21) Appl. No.: 11/138,208

(22) Filed: May 27, 2005

(30) Foreign Application Priority Data
Jun. 1, 2004 (JP) P2004-163261

(51) Int. Cl. B25C 1/04

(52) U.S. Cl. 227/130; 227/156

(57) ABSTRACT

A nail gun is capable of making wear resistance and light-weighted formation compatible with each other by enabling to make a wall thickness of a body or the like as thin as possible by providing a plurality of projected portions having heights in correspondence with wear limits of respective portions at respective portions of a body a head guard for guarding an exhaust cover and the like and reducing wear other than the projected portions.

### BACKGROUND OF THE INVENTION

1. Field of the Invention

The present invention relates to a nail gun provided with a plurality of projected portions projected slightly from a surface of a body. Although an explanation will be given of a nail gun by taking an example of a pneumatic nail gun driven by compressed air as follows, the invention can be applied also to other gas combustion type nail gun or electric nail gun.

2. Description of the Related Art

A nail gun is a portable tool and therefore, light-weighted formation thereof is desired. A body of the nail gun which surrounds an output portion constituted by a cylinder, a piston or the like is formed by a nonferrous light metal material of aluminum, magnesium or the like and also a wall thickness thereof is formed to be as thin as possible.

The nail gun is frequently handled unexpectedly roughly such that the nail gun is placed on a struck member of wood, concrete or the like or dragged. Therefore, as is proposed in JP-A-2002-66956, projections made by, for example, steel plates are provided at upper and lower portions of the body and the projections are made to be first brought into contact with the struck member to thereby protect the body or the like

### SUMMARY OF THE INVENTION

However, the projections are not always first brought into contact with the struck member or the like but there is a case in which other portion of the body is first brought into contact with the struck member or the like. In this case, there poses a problem that a weak portion of the body is worn. Further, there also poses a problem that a degree of wear is difficult to know.

It is an object of the invention to eliminate the above-described drawback of the nail gun of the background art, reduce wear of a main body of a nail gun even when the main body of the nail gun other than a projection is brought into contact with a struck member and enable to easily determine a degree of wear.

A nail gun according to first and second aspects of the intention is characterized in that a plurality of projected portions are provided at a main body of the nail gun or an outer periphery of a body thereof.

According to the nail gun having such a constitution, by providing the projected portions, it is not necessary to make a wall thickness of a total of the main body of the rail gun thick and the nail gun capable of making wear resistance and light-weighted formation compatible with each other can be provided.

A nail gun according to a third aspect of the invention is characterized in that the body is colored.

A nail gun according to a fourth aspect of the invention is characterized in that a plurality of projected portions are provided at an upper face of a head guard covering an exhaust cover.

A nail gun according to a fifth aspect of the invention is characterized in that heights of the projected portions are changed in accordance with wear limits of respective portions of the body and the head guard.

A nail gun according to a sixth aspect of the invention is characterized in that the projected portions are constituted by heights lower than a height of a projection provided at an upper side of the body.

According to the first and second aspects of the invention, the plurality of projected portions are provided at the main body of the nail gun or the outer periphery of the body and therefore, it is not necessary to make the wall thickness of the main body of the nail gun or the total of the body thick and light-weighted formation of the nail gun can be achieved.

According to the third aspect of the invention, the body is colored and therefore, a degree of wear can easily be determined in accordance with a colored situation.

According to the fourth aspect of the invention, the projected portions are provided at the head guard and therefore, a wear situation of the head guard can easily be determined.

According to the fifth aspect of the invention, the heights of the projected portions are changed in accordance with the wear limits of the respective portions of the body and the head guard and therefore, a situation of wearing the respective portions can easily be determined.

According to the sixth aspect of the invention, the heights of the projected portions are made to be lower than the height of the projection provided on the upper side of the body, the heights of the projected portions can pertinently be set in accordance with a difference in ways of wearing by positions of the projected portions, that is, a wear frequency and the main body of the nail gun can be prevented from being enlarged or being heavy more than necessary.

### BRIEF DESCRIPTION OF THE DRAWINGS

FIG. 1 is a side sectional view showing an example of a nail gun;

FIG. 2 is a side view showing an embodiment of the nail gun according to the invention;

FIG. 3 is a rear view of FIG. 2;

FIG. 4 is a sectional view taken along a line A-A of FIG. 2; and

FIG. 5 is a sectional view taken along a line B-B of FIG. 3.

### DETAILED DESCRIPTION OF THE PREFERRED EMBODIMENTS

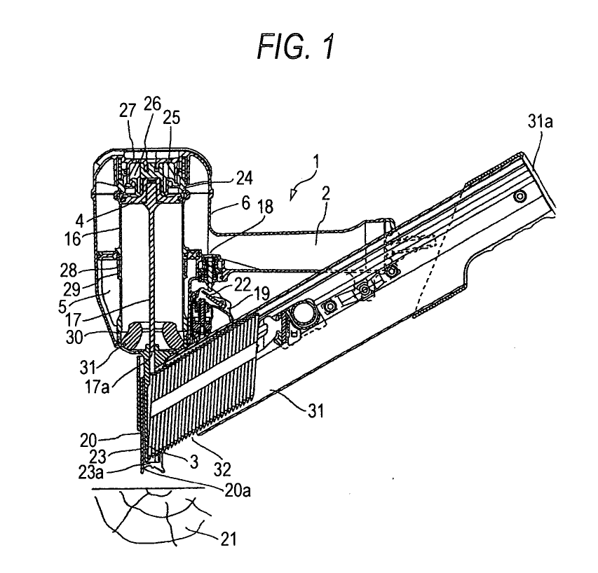

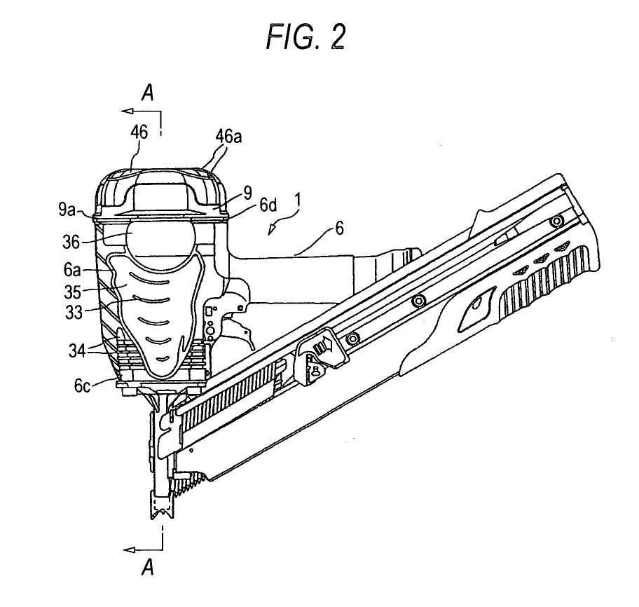

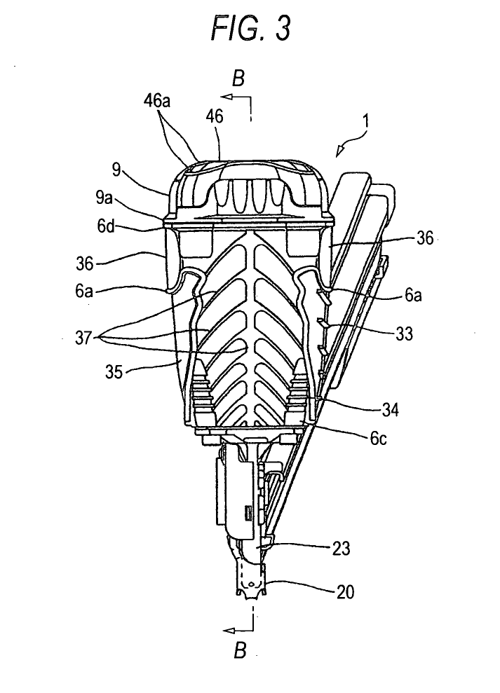

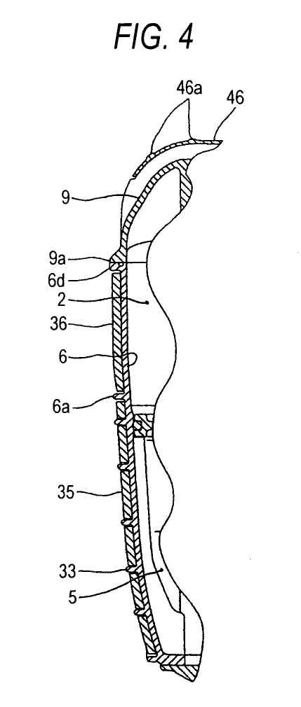

An embodiment or a nail gun of the invention will be described with reference to FIG. 1 through FIG. 5. First, a basic structure and an operation principle of a nail gun 1 will be explained in reference to FIG. 1. Incidentally, an explanation will be given by assuming a direction of striking a nail 3, that is, lower sides of FIG. 1, FIG. 2 as a lower side and assuming a direction opposed thereto as an upper side.

Compressed air from a compressor, not illustrated, is accumulated in an accumulating chamber 2 at inside of a main body of the nail gun 1 via an air hose, not illustrated. The nail gun main body 1 is constituted by a body 6 surrounding an output portion, mentioned later, and including a handle, and an exhaust cover 9 provided on an upper side of the body 6, a head guard 46 for covering an upper face of the exhaust cover 9, a nose 23 attached to a lower end of the body 6 and the like. A cylinder 16 in a cylindrical shape is provided at inside of the nail gun 1, a piston 4 slidable in an up and down direction is provided at inside of the cylinder 16, a driver blade 17 is integrally formed with the piston 4, and the nail is struck by a front end portion 17a. The cylinder 16 and the piston 4 constitute the output portion.

A trigger valve 18 is operated via an arm plate 22 in cooperation with drawing operation of a trigger 19 and operation of pressing a push lever 20 to wood 21 constituting a struck member. The push lever 20 is always urged to a front end side of the nose 23 and when not operated, a push lever lower end 20a is projected from a nose lower end 23a.

The trigger valve 18 and a main valve 24 are cooperatively moved, when the trigger valve 18 is made ON, the main valve 24 is lifted, the main valve 24 is brought into contact with an exhaust valve rubber 25, the accumulating chamber 2 and an air path 26 are closed and the accumulating chamber 2 and an upper side of the piston 4 at inside of the cylinder 16 are communicated. By moving down the main valve 24, an upper end of the cylinder 16 is closed, the main valve 24 is separated from the exhaust valve rubber 25 and the air path 26 is opened. The air path 26 is communicated with the atmosphere via an exhaust hole 27 provided at an upper portion of the main body of the nail gun 1.

An outer periphery of a lower end of the cylinder 16 is provided with a return air chamber 5 for storing compressed air for returning the driver blade 17 to an upper dead center and a center portion in an axial direction thereof is provided with an air path 29 having a check valve 28 and a lower side of the cylinder 26 is provided with an air path 30. A lower end portion of the cylinder 16 is provided with a piston bumper 31 for absorbing excess energy of the driver blade 17 after striking the nail 3.

FIG. 1 shows a state of storing compressed air by connecting the air hose, not illustrated, to the main body of the nail gun 1. Compressed air is stored in the accumulating chamber 2.

When the trigger valve 18 is made ON by executing both of the operation of pulling the trigger 19 and the operation of pressing the push lever 20 to the wood 21, the main valve 24 is moved to the side of the upper dead center, the accumulating chamber 2 and the upper side of the piston 4 at inside of the cylinder 16 are communicated and the accumulating chamber 2 and the air path 26 are blocked from each other.

The nail 3 is struck to the wood 21 while moving the piston 4 abruptly to a side of a lower dead center by compressed air flowing from the accumulating chamber 2 to the upper side of the piston 4 at inside of the cylinder 16. Air on the lower side of the piston 4 at inside of the cylinder 16 flows into the return air chamber 5 via the air path 30, and when the piston 4 passes the air path 29, a portion of compressed air on the upper side of the piston 4 flows into the air chamber 5 via the air path 29.

When the trigger valve 18 is made OFF by returning the trigger 19 or stopping the operation of pressing the push lever 20 to the wood 21, the main valve 24 is moved to a side of the lower dead center. The main valve 24 is closed, the accumulating chamber 2 and the upper side of the piston 4 at inside of the cylinder 16 are blocked from each other, and the upper side of the piston 4 at inside of the cylinder 16 and the atmosphere are communicated by the exhaust valve rubber 25. The lower side of the piston 4 is pressed by compressed air accumulated at the return air chamber 5 and the piston 4 is abruptly moved to the side of the upper dead center. Compressed air on the upper side of the piston 4 is discharged from the exhaust hole 27 to the atmosphere via the air path 26 to return to an initial state.

By repeating the step, the nail 3 at inside of a magazine 31 is successively struck to the wood 21. When the nail 3 is replenished, connected nails 32 which are substantially brought into close contact with each other in parallel are charged from a charge port 31a opened at an end face of the magazine.

FIG. 2 shows an embodiment of the nail gun according to the invention. The body 6 surrounding the output portion of the piston 4 and the like and including the handle is provided with a face plate attaching frame 6a substantially in a triangular shape, 5 pieces of projected portions 33 having a height of about 3 mm are provided at inside of the face plate attaching frame 6a, and 4 pieces of projected portion 34 are provided at an outer periphery of a screw boss 6c for attaching the nose of the body 6 along the outer periphery of the screw boss 6c. Inside of the projected portion 34 is provided with the piston bumper 31, most of excess energy of the driver blade 17 after striking the nail 3 is converted into thermal energy of the piston bumper 31 to generate heat. Particularly, when a soft wood, a short and slender nail are continued to be struck continuously and fast under high pressure, a heat generating amount of the piston bumper 31 is increased and there is a concern of melting the piston bumper 31. Hence, in order to also provide operation of a heat generating fin to the projected portion 34, a height thereof is formed to be as high as about 6 mm. The piston bumper 31 is brought into contact with the nose 23, the nose 23 is brought into contact with the body 6 and is coupled thereto by a screw. The nose 23 is made of a steel material, a specific weight thereof is 7.8 g/cm³, a heat conductivity thereof, is 83.5 w/(m·k), the body 6 is made of aluminum, a specific weight thereof is 2.7 g/cm³ a heat conductivity thereof is 236 w/(m·k) and therefore, with an object of making light-weighted formation and cooling compatible, the projected portion 34 at the outer periphery of the screw boss of the body 6 is formed to be high. A face plate 35 pasted to inside of the face plate attaching frame 6a is provided with 5 pieces of slits, and the projected portions 33 are projected from a surface of the face plate 35 via the slits. An upper side of the face plate 35 is provided with a second face plate 36 and is set to a height which is not projected from the face plate attaching frame 6a similar to the face plate 35.

An upper end of the body 6 is provided with a projection 6d to project from a total periphery thereof. Also a lower end of the exhaust cover 9 is provided with a projection 9a having a height the same as that of the projection 6d to project from a total periphery thereof. The projections 6d and 9a are provided with operation the same as that of the projection of the background art and a height thereof is set to 2.3 mm to be first brought into contact with the struck member or the like.

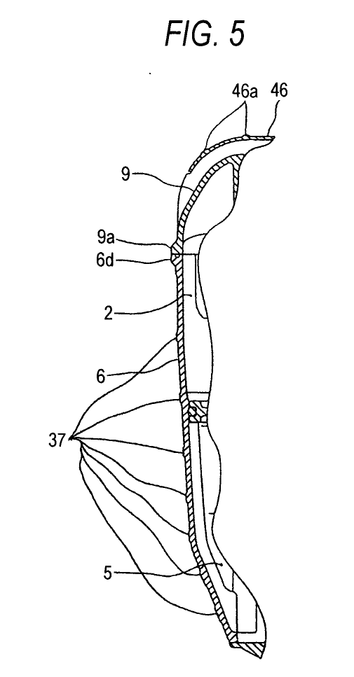

An upper portion of the exhaust cover 9 is attached with the head guard 46 made of stainless steel in a bowl-like shape formed by pressing to cover the upper face of the exhaust cover 9 by, for example, screwing. The head guard 46 increases strength by covering the upper and an angular portion (edge line) of the exhaust cover 9 to serve also as an exhaust cover by utilizing an effect of stainless steel which is not rusted and does not need surface treatment, coating, and heat treatment or the like, a number of parts can be reduced, as a result, an inexpensive nail gun can be provided. An amount of wearing the head guard 46 is small and therefore, a surface thereof is provided with two pieces of projected portions 46a having a height of about 0.5 mm as shown by FIG. 5.

At a rear face of the body 6, a plurality of projected portions 37 are extended in a length direction and a peripheral direction of the body and is formed as if the projected portions 37 were formed in a shape of a fish bone. A wear limit of the rear face of the body 6 is small and therefore, a height of the projected portion 37 is set to be 0.5 mm.

As described above, the nail gun 1 is the portable tool and therefore, light-weighted formation thereof is desired. When the wall thickness of the body is made to be thick in consideration of wear, the nail gun 1 becomes heavy. Therefore, wear resistance and light-weighted formation can be made to be compatible with each other by pertinently setting the heights of the respective projected portions. Further, shapes of the respective projected portions can freely be set, a pattern of the projected portion can freely be set to be in a shape of a fish bone according to the embodiment, and a design performance can be provided to the projected portion. That is, pictures, characters or the like can be designed by using the projected portions.

The body 6 and the exhaust cover 9 are made of aluminum and coated by black color, the head guard 46 is constituted by dull silver color, and the nose 20 is made of a steel material and is constituted by black color by alkali coloring.

When the nail gun 1 is used and the nail gun 1 is brought into contact with the wood 21 or the like in a procedure of the use, at an initial stage of use, colors of the surfaces of the respective projected portions are dropped off and a matrix color emerges in the shape of the projected portion. Further, when the nail gun 1 is brought into contact with the struck member to be worn, the projected portions are eliminated and also colored portions at surroundings of the projected portions are worn, also the surroundings are constituted by matrix color and therefore, wear situation can easily be determined by a change in the color. In the case of the rear face, although the matrix color of aluminum of the body 6 is constituted by the shape of the fish bone of the projected portion 37, the worn portion becomes circular and therefore, further progress of wear is known by a change in the shape of the projected portion 37.

Although according to the above-described embodiment, an explanation has been given of the heights of the respective projected portions by pointing out specific numerical values, for example, a degree of bringing the nail gun 1 into contact with the struck member or the like is not known only by the numerical values of the heights. The degree of contact is changed by a sum of radii and heights of portions provided with the respective projected portions, that is, a distance from the center of the body 6. Radii, heights and the distances from the center of the body are shown below. Further, also radii of the projections 6d, 9a are shown for reference.

| | radius | height | distance from body |
|---|---|---|---|
| projected portion | (mm) | (mm) | center (mm) |
| rear face projected | 50-58 | 0.5 | 50.5-58.5 |
| portion 37 | | | |
| face plate projected | 53-60 | 3 | 56-63 |
| portion 33 | | | |
| projected portion 34 | 8-14 | 6 | 14-20 |
| projections 6d, 9a | 61 -h 62 | 2.3 | 63.3-64.3 |

It is known from the above-described that the distances of the projections 6d, 9a from the center of the body 6 are the longest and the portions are first brought into contact with the struck member or the like.

1. A nail gun for striking a fastening piece to a struck member, comprising;
a main body; and
a plurality of projected portions provided at an outer periphery of the main body.

2. A nail gun comprising:
an output portion including a piston integrally attached with a driver blade for striking a fastening piece and a cylinder slidably supporting the piston for striking the fastening piece by driving the piston and the driver blade by making compressed air flow into the cylinder; and
a nail gun main body including a body surrounding the output portion, an exhaust cover attached to an upper face of the body and a nose attached to a lower end of the body for guiding the driver blade and striking out the fastening piece;
wherein a plurality of projected portions are provided at least at an outer periphery of the body.

3. The nail gun according to claim 2, wherein the body is colored.

4. The nail gun according to claim 3, further comprising:
a head guard covering the exhaust cover;
wherein projected portions are provided at an upper face of the head guard.

5. The nail gun according to claim 2, wherein heights of the projected portions are changed in accordance with respective portions of the body and the head guard and a wear limit thereof.

6. A nail gun comprising:
a body in a cylindrical shape surrounding a drive portion for reciprocating a piston;
a handle portion extended rearward from a rear face of the body;
a magazine portion provided on a lower side of the handle portion for containing a fastening piece;
a nose provided on a lower side of the body for guiding the fastening piece when the fastening piece supplied from the magazine portion is struck by being struck by the piston;
projections having lengths of being projected from left and right side faces of the body in side directions at an upper front face or a rear face of the body; and
a plurality of projected portions provided at an outer periphery of the body and having heights lower than heights of the projections.
